(19) United States
(12) Patent Application Publication
(10) Pub. No.: US 2013/0210533 A1
(43) Pub. Date: Aug. 15, 2013

(54) TORSIONAL VIBRATION DAMPER

(71) Applicants: Franz Kobus, Jettenbach (DE); Johann Loew, Garching (DE)

(72) Inventors: Franz Kobus, Jettenbach (DE); Johann Loew, Garching (DE)

(73) Assignee: SGF Sueddeutsche Gelenkscheibenfabrik GMBH & Co. KG, Waldkraiburg (DE)

(21) Appl. No.: 13/581,017

(22) PCT Filed: Feb. 21, 2011
(86) PCT No.: PCT/EP11/00823

§ 371 Date: Nov. 5, 2012

(30) Foreign Application Priority Data
Feb. 26, 2010 (DE) 10 2010 009 411.0

(51) Int. Cl. F16F 15/14

(52) U.S. Cl. CPC F16F 15/1442
USPC 464/180; 74/574.2

(57) ABSTRACT

The disclosure relates to a torsional vibration damper for damping torsional vibrations of a shaft for industrial applications, including a damper hub having a rotational axis, a damper mass coaxial with the damper hub, and at least one elastomeric damping layer arranged between the damper hub and the damper mass. According to the disclosure, the damper hub and the damper mass are designed in such a way that an outer circumferential surface of the damper hub engages with an inner circumferential surface of the damper mass in a star-shaped manner in the radial direction with respect to the rotational axis, wherein the damper hub and the damper mass are supported against each other in the direction of the rotational axis of the torsional vibration damper by the elastomeric damping layer.

The present invention relates to a torsional vibration damper for damping torsional vibrations of an axle, in particular for industrial applications, comprising a damper hub having a rotational axis, a damper mass coaxial with the damper hub, and at least one elastomeric damping layer disposed between the damper hub and the damper mass.

Such torsional vibration dampers are known from the prior art and are disclosed, for example, in the document EP 1 286 076 A1. This document describes a settable linear damper comprising a two-part damper mass that is connected to a damper carrier by means of elastomeric elements. The two-part damper mass comprises two discs, which are connected to each other, for example by means of screws. The inner circumferential surfaces of the two damper discs constituting the damper mass are conical in form, such that they can correspond to the outer circumferential surface of the damper carrier.

Further, the document EP 1 197 678 A2 discloses a torsional vibration damper comprising a damper carrier disc constituted by two carrier discs, the conical carrier discs being connected to each other by means of screws. At least one of the two carrier discs of the damper carrier disc has an elliptical shape in cross section. A damper mass has a recess shaped so as to correspond to the elliptical shape of the at least one damper disc. The damper mass is connected to the carrier disc by means of elastomeric elements.

The torsional vibration damper designs described above have in common that, precisely in the case of large damper masses, or high rotational speed demands, they cannot adequately guide the damper mass in the axial and radial directions. As a result, the torsional vibration dampers described are very susceptible to imbalances caused by shocks and impacts that occur during operation, which negatively affects their service life.

In addition to the inadequate guidance of the damper mass in the axial and radial directions, described above, the subjecting of the elastomeric elements to relatively large shear forces, which are exerted upon the elastomeric elements by the moment of mass inertia of the damper mass, also negatively affects the service life of the vibration damper of the type described in the documents EP 1 286 076 A1 and EP 1 197 678 A2. The shear forces can result in cracks in the elastomeric elements, or even in their separation from the damper carrier.

It is an object of the present invention to provide a torsional vibration damper, in particular for industrial applications, that has improved vibration damping properties and a long service life when heavy damper masses are used and also in the case of high rotational speeds occurring during operation.

This object is achieved by a torsional vibration damper of the type stated at the outset, wherein the damper hub and the damper mass are designed in such a way that an outer circumferential surface of the damper hub engages with an inner circumferential surface of the damper mass in a star-shaped manner in the radial direction with respect to the rotational axis, the damper hub and the damper mass being supported against each other in the direction of the central axis of the torsional vibration damper by means of the elastomeric damping layer.

By means of the torsional vibration damper according to the invention, the damper mass can be guided in both the axial direction and in the radial direction, as a result of which the axial degree of freedom of the rotational axis of the vibration damper can almost be eliminated. Further, because of the radial guidance, it is possible to prevent imbalances caused by asynchronisms of a shaft connected to the torsional vibration damper. Owing to the star-shaped engagement of the damper hub and damper mass in the radial direction, for the most part only compressive forces act upon the elastomeric damping layer between the damper mass and the damper hub, which elastomeric damping layer, consequently, is substantially not subjected to shear forces, as is the case with the prior art. Consequently, by means of the torsional vibration damper according to the invention, it is also possible to use very heavy damper masses, but without negatively affecting the service life of the torsional vibration damper through use of these damper masses.

According to a preferred embodiment of the invention, the damper hub has on its outer circumferential surface at least one radial projection, which is received in a corresponding recess in the inner circumferential surface of the damper mass. Preferably, in this case, the elastomeric damping layer surrounds the at least one projection of the damper hub. In other words, the damper hub, by means of its radial projection, engages in a recess realized in the inner circumferential surface of the damper mass, via the elastomeric damping layer, as a result of which the elastomeric damping layer is subjected almost exclusively to compressive forces. At the same time, however, the damper mass vibrates with a phase-shifted frequency suitable for compensating the torsional vibrations of the shaft connected to the damper hub.

If relatively large and heavy torsional vibration dampers are required for particular applications, the projection or the projections can also be produced separately from the damper hub and provided with an elastomeric damping layer. The projections are then attached to the damper hub, e.g. screwed to the latter.

The torsional vibration damper according to the present invention can be adapted to particular areas of application, i.e. particular frequency ranges, through the structure of the damper mass, or adaptation of its geometry. Accordingly, it can be provided, according to the invention, that the damper mass is of a multipart, in particular two-part or three-part, construction. The individual parts of the damper mass in this case can be connected to each other by means of connecting elements. The individual parts of the damper mass, which are connected by means of connecting elements such as, for example, screws or rivets, enable the elastomeric damping layer to be biased, such that, in addition to the tuning to a particular frequency, tensile and shear stresses that occur in the damper mass during operation can also be minimized In other words, according to the invention, the individual parts of the damper mass can be tensioned against each other by means of the connecting elements in such a way that the elastomeric damping layer has a predefined bias. Further, owing to the multipart construction of the damper mass, the process of producing the vibration damper according to the invention is simplified considerably, since the damper can be adapted to differing areas of application, or particular frequencies or frequency ranges, without design alterations and without changing the vulcanisation tool. In the production process, the damper hub, while remaining the same, can be provided with a predefined elastomeric damping layer, the damper mass and the connecting means then being used to impart to the damping layer a predefined bias suitable for compensating particular frequencies.

It is to be noted, in connection with this, that the elastomeric damping layer is realized so as to correspond to the at least one projection of the damper hub. In order to match the elastomeric damping layer to the star-shaped engagement between the projections of the damper hub and the recesses in the damper mass, the elastomeric damping layer is preferably realized in a star-shaped manner. The elastomeric damping layer in this case can either be connected to the damper hub or the damper mass, or to the damper hub and the damper mass. As an alternative to this, it is likewise conceivable for the damping layer to be realized as a separate component, which is connected neither to the damper hub nor to the damper mass.

For the purpose of also guiding the damper mass in the axial direction of the rotational axis of the torsional vibration damper, according to a development of the invention the damper mass at least partially surrounds the damper hub, for the purpose of axially supporting the damper mass. In other words, since the damper mass is axially supported on the damper hub, the axial resonant frequency of the vibration damper is decoupled from the torsional resonant is frequency of the vibration damper, this being advantageous for tuning the torsional vibration damper to vibrations occurring in the radial direction.

According to a further embodiment of the invention, the damper mass has on its inner circumferential surface at least one radial projection, which is received in at least one corresponding recess of the damper hub. Preferably, the elastomeric damping layer in this case surrounds the at least one projection of the damper mass. In other words, according to this embodiment, the damper mass is provided, on its inner circumferential surface, with at least one radial projection that, for the purpose of producing the star-shaped engagement, engages radially in a corresponding recess of the damper hub. It is also conceivable here to produce the projections independently of the damper mass, and only subsequently to connect a predefined number of projections to the damper mass.

According to the invention, the damper hub can be of a multipart, in particular two-part or three-part, construction. Preferably in this case, the individual parts of the damper hub are connectable to each other by means of connecting elements. It must additionally be noted in connection with this that the individual parts of the damper hub can be tensioned against each other by means of the connecting elements in such a way that the elastomeric damping layer has a predefined bias. In other words, according to this embodiment, the damper hub at least partially receives the damper mass, thereby enabling the elastomeric damping layer surrounding the projections of the damper mass to be tuned to particular frequency ranges, owing to the multipart construction of the damper mass.

It can be provided, further, that the elastomeric damping layer is realized so as to correspond to the at least one projection. Preferably, the elastomeric damping layer is realized in the shape of a star.

For the purpose of axially guiding the damper mass in the case of this embodiment also, i.e. in order to keep the axial degree of freedom of the damper mass as small as possible, the damper hub surrounds the damper mass for the purpose of axially supporting the latter.

For the purpose of fastening the torsional vibration damper according to the invention to a shaft portion, according to the invention the damper hub has a fastening portion.

Further, the present invention relates to a shaft arrangement having a torsional vibration damper of the type described above.

The invention is explained exemplarily in the following with reference to the appended figures, wherein:

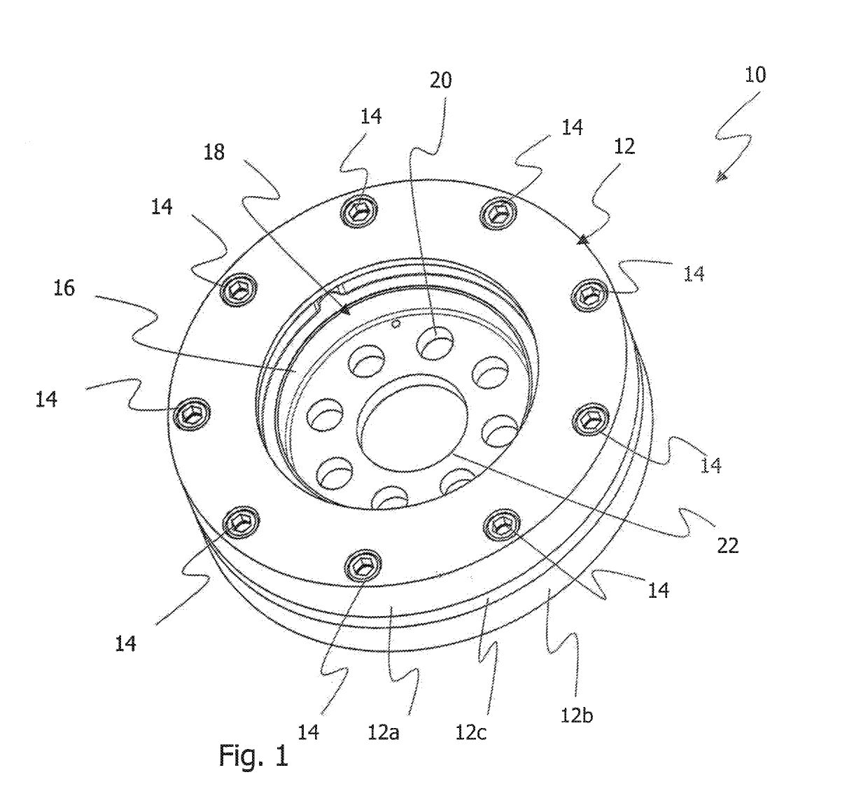

FIG. 1 shows a perspective view of a torsional vibration damper according to a first embodiment of the invention;

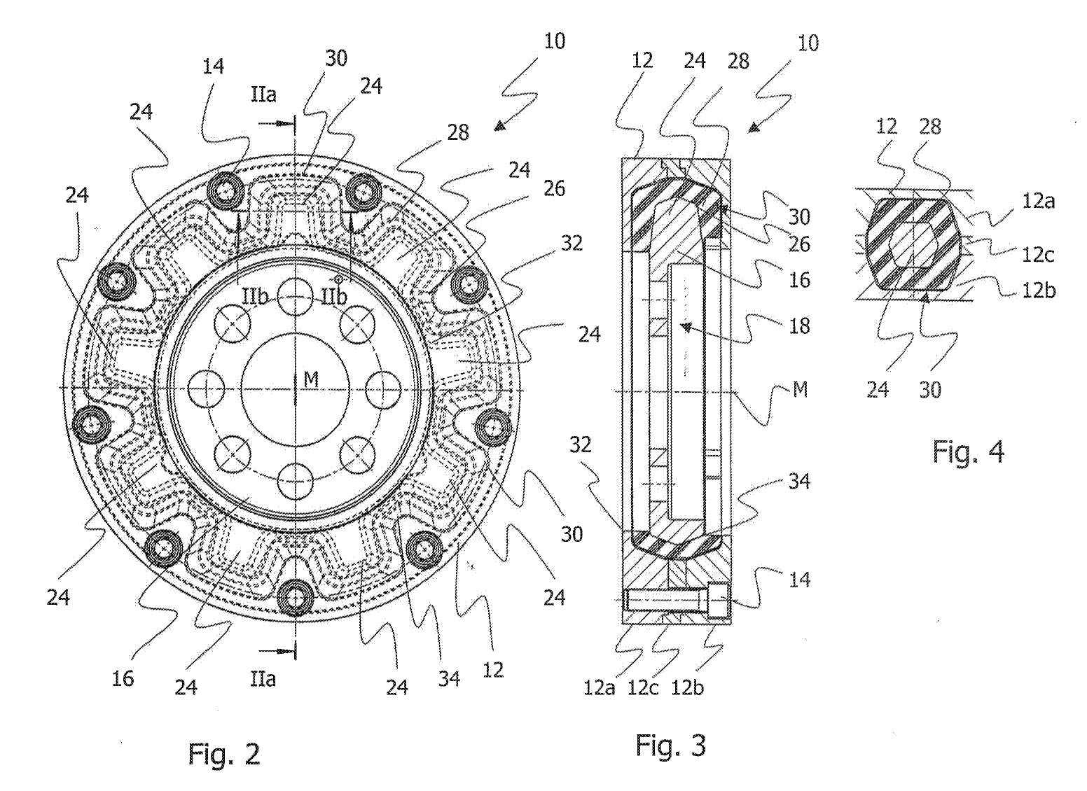

FIG. 2 shows a front view of the first embodiment of the invention;

FIGS. 3 and 4 show sectional views of the first embodiment of the invention;

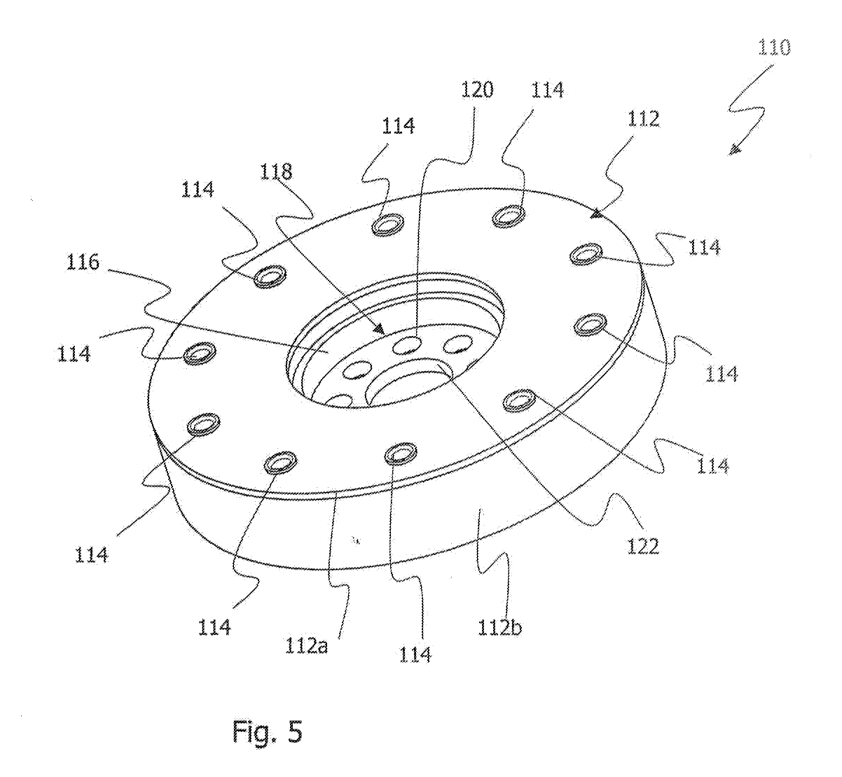

FIG. 5 shows a perspective view of a torsional vibration damper according to a second embodiment of the invention;

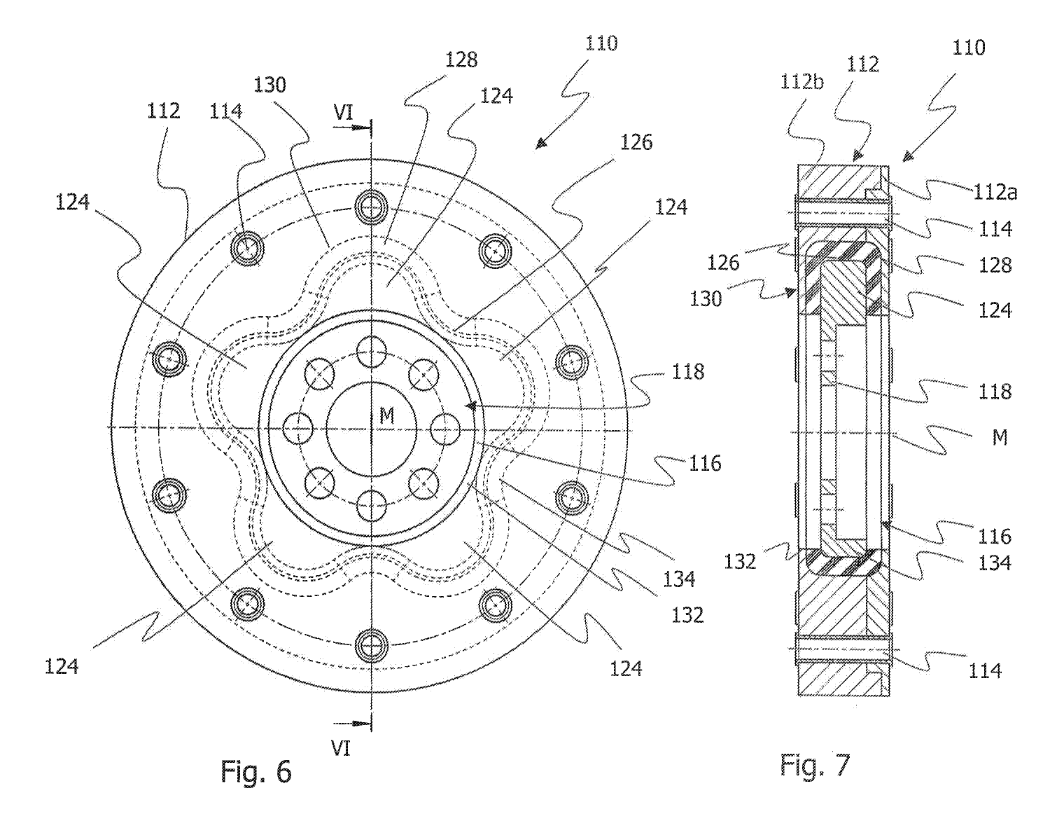

FIG. 6 shows a front view of the second embodiment of the invention;

FIG. 7 shows a sectional view of the second embodiment of the invention;

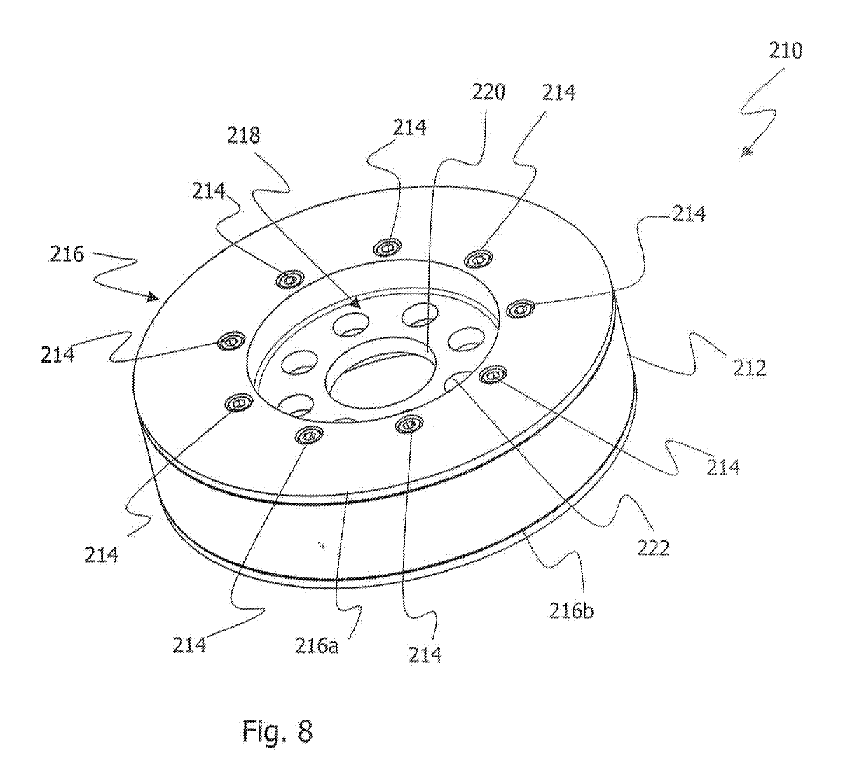

FIG. 8 shows a perspective representation of a torsional vibration damper according to a third embodiment of the invention;

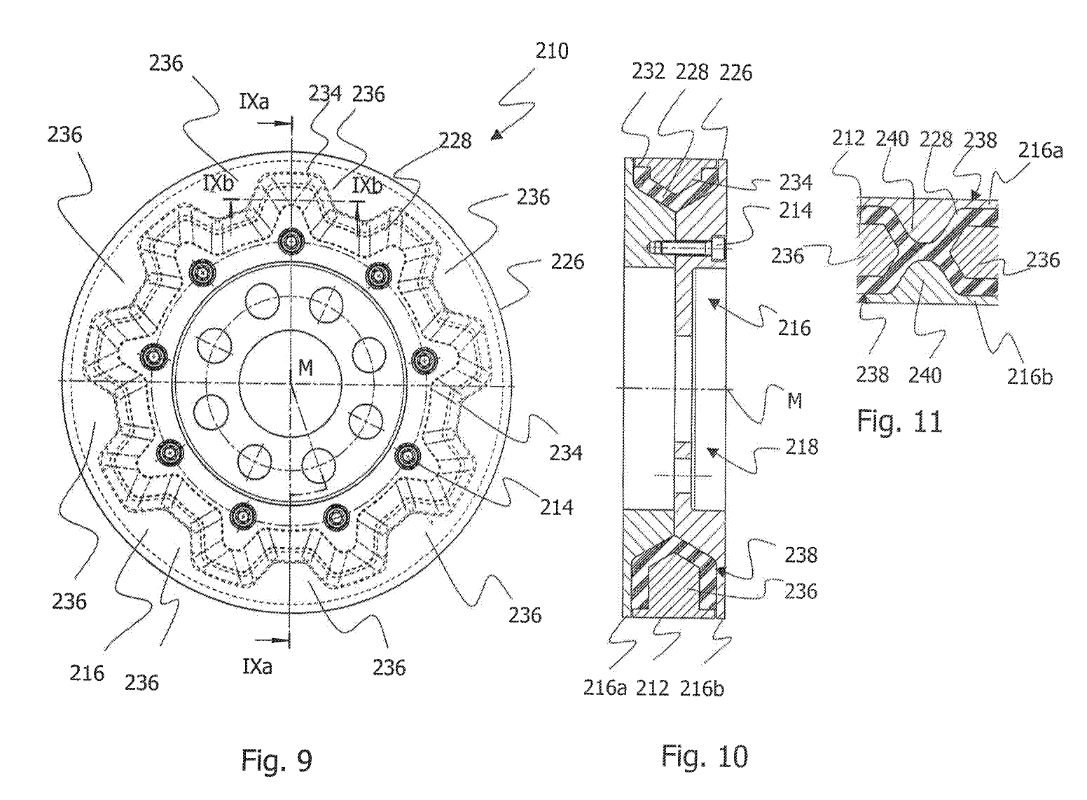

FIG. 9 shows a front view of the third embodiment of the invention; and

FIGS. 10 and 11 shows sectional views of the third embodiment of the invention.

FIG. 1 shows a perspective view of a torsional vibration damper according to a first embodiment of the invention, the torsional vibration damper being denoted in general by 10.

FIG. 1 shows the damper mass 12, which is of a three-part construction, having two outer damper mass discs 12a and 12b, and an intermediate disc 12a disposed between the damper mass discs 12a and 12b. The damper mass discs 12a, 12b and the intermediate disc 12c are connected to each other by means of screws 14.

Further, FIG. 1 shows that the damper mass 12 at least partially surrounds a damper hub 16. The damper hub 16 has a fastening portion 18, by means of which the damper hub 16 can be attached to a shaft portion, not shown here. The damper hub 16 in this case can be screwed to a shaft portion via the openings 20 and/or fitted onto a shaft portion by means of the opening 22. Further, the openings 20, 22 can serve as an engagement for tools during the production process.

FIG. 2 shows a front view of the torsional vibration damper 10 according to the first embodiment.

It can be seen in this case from FIG. 2 that the damper hub 16 is provided with projections 24, which project in the radial direction from its outer circumferential surface 26 and which are distributed uniformly around the circumference of the damper hub 16. The individual projections 24 are offset at regular angular distances in relation to each other, by 40° in the case of this embodiment. Accordingly, the damper hub 16 according to this embodiment has a form similar to that of a toothed wheel that, by means of its teeth, or projections 24, engages in a star-shaped manner with the damper mass 12.

Although an elastomeric damping layer 28 and recesses 30 (represented as concealed in FIG. 2) in the damper mass 12 are already indicated in FIG. 2, the elastomeric damping layer 28 and the recesses 30 can be seen clearly in FIG. 3, which shows a sectional view along the section line IIa-IIa from FIG. 2.

The elastomeric damping layer 28 surrounds the projections 24 of the damper hub 16, which project radially in a star-shaped manner. As already mentioned, the damper mass 12 comprises the recesses 30, which correspond to the projections 24 and which are realized in the inner circumferential surface 32 of the damper mass 12 constituted by the damper mass discs 12a, 12b, 12c and extend into the damper mass 12 in the radial direction. The damper mass discs 12a, 12b, 12c (not shown in FIG. 2) are connected to each other by means of the screws 14, to enable the elastomeric damping layer 28 to be set with a predefined bias for the purpose of setting to a particular torsional vibration frequency. The screws 14 are preferably provided in regions between the recesses 30 of the damper mass 12.

The three-part construction of the damper mass 12, comprising the damper mass discs 12a, 12b and the intermediate disc 12c, is shown clearly by FIG. 3. The two damper mass discs 12a, 12b and the intermediate disc 12c are clamped by means of the screws 14, in order to impart a predefined bias to the elastomeric damping layer 28. The projection 24 of the damper hub 16 is received in the recess 30 in the damper mass 12 that is constituted by the damper discs 12a, 12b and the intermediate disc 12c, and is connected to the damper mass 12 by means of the elastomeric damping layer 28.

The damper mass 12, or the damper discs 12a and 12b, surrounds, or surround, the damper hub 16 almost as far as the fastening portion 18, in order that deflections of the damper mass 12 in the direction of the rotational axis M relative to the damper hub 16 can be limited. In other words, during operation of the torsional vibration damper 10, the damper mass 12 can be supported against the damper hub 16 by means of the elastomeric damping layer.

It can further be seen from the sectional view according to FIG. 3 that the damper hub 16 also extends radially, even if to a small extent, into the damper mass 12, in intermediate regions 34 between the individual projections 24, or is received by the damper mass 12, and is connected to the damper mass 12 by means of the elastomeric damping layer 28.

FIG. 4 shows a sectional view along the section line IIb-IIb from FIG. 2. Again, the figure to shows the damper mass discs 12a, 12b and the intermediate disc 12c, which together constitute the recesses 30, in which the projection 24 of the damper hub 16 is received. The projection 24 of the damper hub 16 engages with the recess 30 via the elastomeric damping layer 28.

By comparing FIGS. 2 to 4, it can be seen how the damper mass 12 partially surrounds the damper hub 16, thereby achieving axial guidance of the damper mass 12. Since the damper hub 16 engages radially with the damper mass 12 in a star-shaped manner, the damper mass can also be supported in the radial direction against the projections 24 of the damper hub 16, by means of the elastomeric damping layer 28 (FIG. 3). This is due to the fact that the outer circumferential surface 26 of the damper hub 16, including the projections 24, is surrounded by the elastomeric damping layer 28.

The vibration damping properties of the torsional vibration damper 10 in the torsional, radial and axial directions are defined, or set, by means of the elastomeric damping layer 28.

The amplitude of the damper mass 12 relative to the damper hub 16 is determined by the elastomeric damping layer 28, since the latter surrounds the projections 24 and likewise bears on the recesses 30 in the damper mass 12. During operation, the damper mass 12, owing to its moment of mass inertia, is displaced in the circumferential direction of the torsional vibration damper 10, continuing to compress the damping layer 28, relative to the damper hub 16, until the projections 24 bear against the recesses 30 in the damper mass 12 and limit the displacement. In other words, a maximally permitted amplitude is determined by the damping layer 28 filling an intermediate space between the projections 24 and the recesses 30. The displacement in the circumferential direction, or this relative rotation between the damper mass 12 and the damper hub 16, is required in order that torsional vibrations of a shaft (not shown) connected to the torsional vibration damper 10 can be damped.

Since the projections 24 are also in contact with the recesses 30 in the radial and axial directions via the elastomeric damping layer 28, the damper mass 12 is guided in both the radial and axial directions, such that the torsional vibration damper 10 has a high degree of stiffness radially and axially.

Further embodiments of the invention are described in the following. Components that are of the same type or have the same function are denoted by the same references, but with a consecutive numeral prefix.

FIG. 5 shows a perspective view of a second embodiment of the invention, comprising a damper mass 112, of a two-part construction, which is constituted by the damper mass discs 112a and 112b. In the case of this embodiment of the invention, the damper mass discs 112a and 112b are connected to each other by means of rivets 114, and again partially surround the damper hub 116, of which a portion of the fastening portion 118 can be seen in FIG. 5.

FIG. 6 shows a front view of the vibration damper 110, wherein the damper hub 116 has projections 124 that, via the elastomeric damping layer 128, engage in a star-shaped manner in corresponding recesses 130 in the damper mass 112.

The damper hub 116 is not realized in a manner similar to a toothed wheel, as in the case of the first embodiment. Although the projections 124 do project in a star-shaped manner from the outer circumferential surface 126 of the damper hub 116, the individual projections 124 are rounded. Since, as can be seen from FIG. 6, not only the projections 124, but also the intermediate portions 134 between the individual projections 124 are rounded, the individual projections 124 graduate harmoniously into each other. The damper hub 116 thus has an undulated circumferential shape. Accordingly, the recesses 130 in the damper mass 112, which are merely indicated in FIG. 6, are likewise realized in a harmonious manner, i.e. the individual recesses 130 in the damper mass 112 graduate harmoniously into each other in such a way that there is a star-shaped engagement in the radial direction between the damper mass 212 and the damper hub 216.

The individual projections 124 here are offset at regular angular distances in relation to each other, starting from their apex, by 72° in the case of this embodiment.

FIG. 7 shows a sectional view along the section line VI-VI from FIG. 6. It can be seen from FIG. 7 how the damper discs 112a and 112b are connected to each other by means of the rivets 114, in order to impart to the elastomeric damping layer 128 a predefined bias suitable for compensating a particular torsional vibration frequency. Again, it can be seen how the damper mass discs 112a and 112b surround the damper hub 116, or its projections 124, to enable the damper mass 112 to be supported against the damper hub 116. Also shown here are the projections 124, which are realized in a regular manner in the circumferential direction and received in recesses 130 realized in the damper mass discs 112a and 112b. In other words, the circumferential shape of the damper hub 116 is matched to the structural shape of recesses 130 in the damper mass 112.

FIG. 8 shows a perspective view of the torsional vibration damper 210 according to a third embodiment.

It can already be seen from what is indicated in the perspective view according to FIG. 8 that the damper hub 216 is realized in two parts, i.e. having a damper hub disc 216a and a damper hub disc 216b, which are connected to each other by means of screws 214. The damper hub discs 216a and 216b surround the damper mass 212, such that the damper mass 212 can be supported in the axial direction against the damper hub discs 216a and 216b, which are realized in a flange-like manner.

FIG. 9 shows a front view of the torsional vibration damper 210, from which it can be seen that radially inwardly projecting projections 232 are now realized on the damper mass 212, which projections are received in corresponding recesses 238 constituted by the damper hub discs 216a and 216b. The damper hub 216 having the recesses 238 thus engages radially in a star-shaped manner with the projections 236 of the damper mass 212 by means of the elastomeric damping layer 228.

In order that a predefined bias can be imparted to the elastomeric damping layer 228 in the case of this embodiment, likewise, the two damper hub discs 216a and 216b are screwed to each other by means of the screws 214. It can be seen, in comparison with the two embodiments previously described, that the screws 214 are now disposed considerably closer to the rotational axis M of the torsional vibration damper 210, in order that the two damper hub discs 216a and 216b can be connected to each other.

FIG. 10 shows a sectional view along the sectional line IXa-IXa from FIG. 9, from which it can be seen that, in the case of this embodiment, the two damper hub discs 216a and 216b surround the damper mass 212 to allow the damper mass 212 to be supported axially against the damper hub discs 216a and 216b, by means of the elastomeric damping layer 228.

The two damper hub discs 216a and 216b, starting from their outer circumferential surface 226, constitute the recesses 238 in which the corresponding projections 236 of the damper mass 212 are received, or in which the projections 236 engage in a star-shaped manner in the radial direction. It can be seen from FIG. 10 in this case that the damper mass 216, in intermediate portions 234 between the individual projections 236, also extends into the damper hub 216 in the radial direction, or the intermediate portions 234 are received by the damper hub 216.

In the case of this embodiment, the projections 236 on the damper mass 212 are offset in relation to each other at regular angular distances of 40° on the inner circumferential surface 232 of the damper mass 212.

FIG. 11 shows a sectional view along the section line IXb-IXb. FIG. 11 shows the two projections 236 realized on the damper mass 212, as well as the recesses 238 that are realized in the damper hub 216 and in which the projections 236 of the damper mass 212 are received. Between the recesses 238, the damper hub discs 216a and 216b have portions 240 that extend in the direction of the respectively other damper hub disc 216a or 216b, in order that a radial engagement can be produced between the damper mass 212 and the damper hub 216. In other words, during operation, the projections 236 can bear on the portions 240, compressing the elastomeric damping layer 228. The elastomeric damping layer 228, which completely surrounds the projections 236 of the damper mass 212, likewise extends between the portions 240.

By comparing FIGS. 9 to 11, it can be seen that the damper mass 212 can be supported against the damper hub discs 216a and 216b in the direction of the rotational axis M of the torsional vibration damper 310, as a result of which the damper mass 212 is guided in the axial direction, in order that the radial resonant frequency of the torsional vibration damper can be tuned independently of the axial resonant frequency of the torsional vibration damper 210.

Further, the damper mass 212 is guided radially by the radial engagement of its projections 236 in the recesses 238 of the damper hub 216, it being possible to use the hardness or differing, other material properties of the elastomeric damping layer 228 to effect tuning of the torsional vibration damper 210.

The tuning of the torsional vibration damper 210 to torsionally occurring vibrations is also effected by means of the elastomeric damping layer 228, since the amplitude at which the damper mass 212 vibrates out of phase in relation to the damper hub 216 is defined by means of the elastomeric damping layer. The maximally allowable amplitude at which the damper mass 212 can vibrate in phase opposition in relation to the damper hub 216 is defined by the intermediate spaces, filled with the elastomeric damping layer 228, between the projections 236 of the damper mass 212 and the recesses 238 of the damper hub 216. In other words, after attaining the maximally allowable amplitude, the damper mass 212, compressing the elastomeric damping layer 228, bears against the portions 240 of the damper hub discs 216a and 216b. What is also achieved at the same time by such a design of the torsional vibration damper 210 is that the elastomeric damping layer 228 is for the most part subjected only to compressive forces.

What is claimed is:

1-11. (canceled)

12. A torsional vibration damper for damping torsional vibrations of a shaft, comprising:
a damper hub having a rotational axis;
a damper mass coaxial with the damper hub; and
at least one elastomeric damping layer disposed between the damper hub and the damper mass,
the damper hub and the damper mass configured such that an outer circumferential surface of the damper hub engages with an inner circumferential surface of the damper mass in a star-shaped manner in a radial direction with respect to the rotational axis, the damper hub and the damper mass being supported against each other in a direction of the rotational axis of the torsional vibration damper by the elastomeric damping layer,
wherein the damper hub includes on its outer circumferential surface at least one radial projection, which is received in a corresponding recess in the inner circumferential surface of the damper mass, the elastomeric damping layer surrounding the at least one radial projection of the damper hub in an axial and in a radial direction,
wherein the damper mass surrounds the damper hub at least partially for axial support.

13. The torsional vibration damper according to claim 12, wherein the damper mass is of a multipart construction, wherein individual parts of the damper mass are connectable to each other by connecting elements.

14. The torsional vibration damper according to claim 13, wherein the individual parts of the damper mass can be tensioned against each other by the connecting elements such that the elastomeric damping layer has a predefined bias.

15. The torsional vibration damper according to claim 12, wherein the elastomeric damping layer is realized so as to correspond in a star-shaped manner, to the at least one radial projection of the damper hub.

16. The torsional vibration damper according to claim 12, wherein the damper hub is of a multipart construction, wherein individual parts of the damper hub are connectable to each other by connecting elements.

17. The torsional vibration damper according to claim 16, wherein the individual parts of the damper hub can be tensioned against each other by the connecting elements such that the elastomeric damping layer has a predefined bias.

18. The torsional vibration damper according to claim 12, wherein the damper hub has a fastening portion for fastening to a shaft portion.

19. A shaft arrangement having a torsional vibration damper according to claim 12.

20. A torsional vibration damper for damping torsional vibrations of a shaft, comprising:
a damper hub having a rotational axis;
a damper mass coaxial with the damper hub; and
at least one elastomeric damping layer disposed between the damper hub and the damper mass,
the damper hub and the damper mass configured such that an outer circumferential surface of the damper hub engages with an inner circumferential surface of the damper mass in a star-shaped manner in a radial direction with respect to the rotational axis, the damper hub and the damper mass being supported against each other in a direction of the rotational axis of the torsional vibration damper by the elastomeric damping layer,
the damper mass has on its inner circumferential surface at least one radial projection, which is received in at least one corresponding recess of the damper hub, the elastomeric damping layer surrounding the at least one radial projection of the damper mass, in an axial and in a radial direction,
wherein the damper hub surrounds the damper mass at least partially for axial support.

21. The torsional vibration damper according to claim 20, wherein the damper mass is of a multipart construction, wherein individual parts of the damper mass are connectable to each other by connecting elements.

22. The torsional vibration damper according to claim 21, wherein the individual parts of the damper mass can be tensioned against each other by the connecting elements such that the elastomeric damping layer has a predefined bias.

23. The torsional vibration damper according to claim 20, wherein the damper hub is of a multipart construction, wherein individual parts of the damper hub are connectable to each other by connecting elements.

24. The torsional vibration damper according to claim 23, wherein the individual parts of the damper hub can be tensioned against each other by the connecting elements such that the elastomeric damping layer has a predefined bias.

25. The torsional vibration damper according to claim 20, wherein the elastomeric damping layer is realized so as to correspond in a star-shaped manner, to the at least one radial projection of the damper mass.

26. The torsional vibration damper according to claim 20, wherein the damper hub has a fastening portion for fastening to a shaft portion.

27. A shaft arrangement having a torsional vibration damper according to Claim 20.
